(19) United States
(12) Patent Application Publication
(10) Pub. No.: US 2026/0128250 A1
(43) Pub. Date: May 7, 2026

(54) COOLED ANODES, X-RAY TUBES, AND METHODS OF FORMING THE SAME

(71) Applicant: VAREX IMAGING CORPORATION, Salt Lake City, UT (US)

(72) Inventors: Brandon Robbins, South Jordan, UT (US); Matt Pierce, Kaysville, UT (US); Gregory C. Andrews, West Jordan, UT (US); Kasey Otho Greenland, South Jordan, UT (US)

(21) Appl. No.: 19/349,632

(22) Filed: Oct. 3, 2025

Related U.S. Application Data
(60) Provisional application No. 63/717,122, filed on Nov. 6, 2024.

(51) Int. Cl. H01J 35/12; H01J 9/14

(52) U.S. Cl. CPC H01J 35/13; H01J 9/14; H01J 2235/1204

(57) ABSTRACT

Anodes with integrated heat exchangers, x-ray tubes including the same, and methods of manufacturing anodes are disclosed. An anode for an x-ray tube can include a body portion defining an inner channel, an outer channel, and a radial channel. The radial channel can be configured to direct a coolant between the inner channel and the outer channel.

### CROSS-REFERENCE TO RELATED APPLICATION(S)

This application claims priority to U.S. Provisional Application No. 63/717,122 filed 6 Nov. 2024, the entire disclosure of which is hereby incorporated by reference.

### FIELD

The described embodiments relate generally to x-ray tubes, and more particularly, to x-ray tubes including anodes with integrated heat exchangers that provide improved thermodynamic properties, including improved cooling.

### BACKGROUND

X-ray tubes are tools that are used in a wide variety of applications, both industrial and medical. An x-ray tube typically includes a cathode assembly and an anode positioned within an evacuated enclosure. The cathode assembly includes an electron source, and the anode includes a target surface that is oriented to receive electrons emitted by the electron source. During operation of the x-ray tube, an electric current is applied to the electron source, which causes electrons to be produced by thermionic emission. The electrons are accelerated toward the target surface of the anode by applying a high-voltage potential between the cathode assembly and the anode. When the electrons strike the anode target surface, the kinetic energy of the electrons causes the production of x-rays. The x-rays are produced omnidirectionally. The x-ray tube can include a window through which a portion of the x-rays exits the x-ray tube. The x-rays that exit the x-ray tube can then interact with a material sample, a patient, or another object.

The generation of x-rays in an x-ray tube can also generate heat in components of the x-ray tube. In some examples, this heat can damage the components of the x-ray tube. For example, when electrons impact the anode target surface, some of their kinetic energy can be converted to x-rays, while at least a portion of their kinetic energy can be converted to heat. This heat can raise temperatures of the anode and other structures of the x-ray tube. High temperatures in the anode and other structures of the x-ray tube can damage the components of the x-ray tube and shorten its operational life. As such, it is desirable to produce x-ray tubes with improved heat dissipation to prevent damage to the x-ray tubes, extend the operational life of the x-ray tubes, and the like. Further, improving heat dissipation in the x-ray tubes can allow for the x-ray tubes to operate with higher power capacity, which can increase performance of the x-ray tubes.

### SUMMARY

One aspect of the present disclosure relates to an anode for an x-ray tube, the anode including a body portion defining an inner channel, an outer channel, and a radial channel. The radial channel can be configured to direct a coolant between the inner channel and the outer channel.

In some examples, the inner channel can be configured to direct the coolant in a first direction. The outer channel can be configured to direct the coolant in a second direction opposite the first direction.

In some examples, the anode can further include a plurality of extended surfaces extending into the inner channel. In some examples, a surface of the body portion facing away from the inner channel can include a plurality of extended surfaces extending into the outer channel. In some examples, a surface of the body portion facing towards the inner channel can include a plurality of extended surfaces extending into the outer channel.

In some examples, the anode can further include an end plate coupled to the body portion. The end plate can at least partially define the radial channel. The end plate can have a thickness in a range from 0.2 inches to 0.5 inches.

In some examples, the anode can further include an end plate coupled to the body portion and an x-ray target layer attached to a first surface of the end plate. The radial channel can be configured to direct the coolant along a second surface of the end plate opposite the first surface.

In some examples, the body portion can include a plurality of outer channels disposed at different radial distances in the body portion.

Another aspect of the present disclosure relates to an x-ray tube including a cathode, an anode defining a plurality of channels, a cooling system coupled to the channels, the cooling system comprising a coolant inlet and a coolant outlet, and an enclosure at least partially surrounding the cathode, the anode, and the cooling system. The channels can include an inner channel configured to flow a coolant in a first direction and an outer channel configured to flow the coolant in a second direction opposite the first direction.

In some examples, the channels can further include a radial channel in fluid communication with the inner channel and the outer channel.

In some examples, the cooling system can be coupled to the channels at a proximal end of the anode. The radial channel can be disposed within a distal end of the anode.

In some examples, the coolant inlet and the coolant outlet can be arranged concentric to one another.

In some examples, the channels can further include a plurality of outer channels. The outer channels can be disposed at greater radial distances from a center of the anode than the inner channel. The outer channels can at least partially encircle the inner channel. In some examples, the channels can further include a plurality of radial channels. Each of the radial channels can be in fluid communication with the inner channel and at least two of the outer channels.

In yet another aspect of the present disclosure, a method of manufacturing an anode includes providing a body portion and coupling an end plate to the body portion. The body portion can define a first channel and a second channel extending through a length of the body portion. The end plate can at least partially define a radial channel fluidly coupled between the first channel and the second channel.

In some examples, providing the body portion can include concentrically arranging a first body portion relative to a second body portion and coupling the first body portion to the second body portion.

In some examples, providing the body portion can include concentrically arranging a first body portion relative to a second body portion. The first body portion and a second body portion can define the first channel and the second channel. Coupling the end plate to the body portion can include coupling the first body portion and the second body portion to the end plate.

In some examples, providing the body portion can include machining the first channel and the second channel in the body portion. In some examples, providing the body portion can further include machining the body portion to at least partially define the radial channel.

In some examples, the method can further include forming the body portion by an additive manufacturing process.

One aspect of the present disclosure relates to an anode for an x-ray tube, the anode including a body portion defining an inner channel, an outer channel, and a radial channel. The radial channel can be configured to direct a coolant between the inner channel and the outer channel. The anode can further include a wall portion coupled to the body portion. The wall portion can at least partially define the outer channel.

In some examples, the wall portion can at least partially encircle the body portion. The outer channel can be defined between the body portion and the wall portion. In some examples, the body portion can at least partially encircle the wall portion. The outer channel can be defined between the body portion and the wall portion. The radial channel can be defined between the body portion and the wall portion.

In some examples, the anode can further include a protrusion coupled to the body portion. The protrusion can at least partially define the inner channel.

In some examples, the radial channel can extend from the inner channel at an angle relative to a radial direction of the anode. In some examples, the radial channel can extend from the inner channel at an angle within 10 degrees of a tangent to an inner surface of the body portion that defines the inner channel. In some examples, the radial channel can extend from the inner channel at an angle from 60 to 80 degrees of a tangent to an outer surface of the body portion that defines the outer channel.

In some examples, the inner channel can be configured to direct the coolant in a first direction. The outer channel can be configured to direct the coolant in a second direction opposite the first direction.

In some examples, the anode can further include a plurality of extended surfaces extending from the body portion into the outer channel. In some examples, the anode can further include an x-ray target layer coupled to a first surface of the body portion. The body portion can include a single continuous material extending from the first surface and defining the radial channel.

In some examples, a ratio of an outer diameter of the outer channel to an outer diameter of the body portion can be in a range from 0.8 to 0.95.

Another aspect of the present disclosure relates to an x-ray tube including a cathode, an anode defining a plurality of channels, a cooling system coupled to the channels, and an enclosure at least partially surrounding the cathode, the anode, and the cooling system. The plurality of channels can include an inner channel configured to flow a coolant in a first direction, an outer channel configured to flow the coolant in a second direction opposite the first direction, and a radial channel configured to flow the coolant between the inner channel and the outer channel in a third direction perpendicular to the first and second directions and angled relative to a centerline of the anode. The cooling system can include a coolant inlet and a coolant outlet.

In some examples, the radial channel can extend in a plane perpendicular to the centerline of the anode.

In some examples, the anode can further include an x-ray target layer coupled to a first surface of the anode. The cooling system can be coupled the anode adjacent to a second surface of the anode opposite the first surface. The anode can include a single continuous material extending from the first surface to the second surface.

In some examples, the anode can include a body portion at least partially defining the inner channel, the outer channel, and the radial channel, and an outer wall coupled to the body portion. The outer wall can at least partially encircle the body portion. The outer wall can at least partially define the outer channel between the outer wall and the body portion.

In some examples, the anode can include a body portion at least partially defining the inner channel, the outer channel, and the radial channel, and a protrusion coupled to the body portion. The body portion can at least partially encircle the protrusion. The protrusion can at least partially define the inner channel between the body portion and the protrusion.

In yet another aspect of the present disclosure, a method of manufacturing an anode includes providing a body portion, machining a first planar surface of the body portion to form an inner channel, and machining a circumferential surface of the body portion to form a radial channel fluidly coupled to the inner channel.

In some examples, the method can further include concentrically arranging an outer wall relative to the body portion and coupling the outer wall to the body portion.

In some examples, the method can further include arranging a protrusion in the inner channel of the body portion and coupling the protrusion to the body portion.

In some examples, the radial channel can be machined at an angle relative to a centerline of the body portion and a radial direction of the anode.

In some examples, the method can further include machining the circumferential surface of the body portion to form a plurality of extended surfaces extending perpendicular to the first surface.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a partial section side view of an x-ray tube.

FIG. 2A is a cross-sectional view a portion of an x-ray tube including an anode and a cooling system.

FIG. 2B is a cross-sectional view of the anode and the cooling system of FIG. 2A.

FIG. 3A is a top isometric exploded view of an anode.

FIG. 3B is a bottom isometric exploded view of the anode of FIG. 3A.

FIG. 3C is a partial perspective section view of the anode of FIG. 3A and illustrates a flow path through the anode.

FIG. 3D is a bottom-up view of a body portion of the anode of FIG. 3A.

FIG. 3E illustrates an aspect of the subject matter in accordance with one embodiment.

FIG. 4A is a cross-sectional view of an anode.

FIG. 4B is a bottom-up view of a body portion of the anode of FIG. 4A.

FIG. 5 is an exploded side view of an anode.

FIG. 6 is a flowchart of a method of manufacturing an anode.

FIG. 7A illustrates an aspect of the subject matter in accordance with one embodiment.

FIG. 7B illustrates an aspect of the subject matter in accordance with one embodiment.

FIG. 7C illustrates an aspect of the subject matter in accordance with one embodiment.

FIG. 8A is a top-down view of an anode.

FIG. 8B is a cross-sectional view of the anode of FIG. 8A and a portion of a cooling system.

FIG. 8C is a partial cross-sectional view of the anode of FIG. 8A and illustrates a flow path through the anode.

FIG. 8D is an exploded side view of an anode.

FIG. 9A is a top-down view of an anode.

FIG. 9B is a cross-sectional view of the anode of FIG. 9A and a portion of a cooling system.

FIG. 9C is an exploded side view of an anode.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to x-ray tubes used to generate x-rays. Representative applications for x-ray tubes include, but are not limited to, imaging, medicine, diagnostics, radiology, radiotherapy, radiography and tomography, and a range of industrial x-ray technologies. More specifically, the following disclosure relates to anodes for x-ray tubes that include integrated heat exchangers. The heat exchangers may be channels (e.g., inner channels, radial channels, and outer channels) formed in the body of the anode, which allow for a coolant to flow through the body of the anode. The heat exchangers can be used to improve heat transfer (e.g., heat dissipation) and thermodynamic properties of the anodes.

An x-ray tube can include a cathode, an anode, and a cooling system, each of which can be disposed at least partially within an evacuated enclosure. The anode can include an inner channel configured to flow coolant in a first direction and an outer channel configured to flow coolant in a second direction opposite the first direction. The coolant can enter and exit the anode at a proximal end of the anode. The anode can further include a radial channel in fluid communication with the inner channel and the outer channel. The radial channel can be disposed at a distal end of the anode, near a target surface of the anode. This arrangement can allow for heat to be transferred from the anode to the coolant throughout the anode and can particularly increase heat transfer from the anode to the coolant at the distal end of the anode (e.g., near the target surface of the anode). This arrangement can provide thermal communication between the anode and the coolant throughout the anode. This increases heat transfer from the anode to the coolant and improves heat dissipation from the anode. Heat transfer between the anode and the coolant can further be increased by increasing a surface are between the anode and the coolant and/or increasing a velocity of the coolant through the anode. As a result, the longevity of the anode can be improved, and the anode can be used in x-ray tubes with higher power capacities.

An anode for an x-ray tube can be formed by various methods. For example, an inner channel and outer channels of the anode can be formed in a body portion of the anode. An end plate can be coupled to the body portion, and radial channels can be defined between the end plate and the body portion. The radial channels can be formed in surface(s) of the body portion and/or the end plate. The radial channels can be at least partially defined by the body portion and the end plate. This can allow for the radial channel to be formed at a distal end of the anode, such as near a target surface of the anode.

The body portion can be a single-piece or unitary component or can be a multi-piece component. In an example in which the body portion is a unitary component, the inner channel and the outer channels can be defined in the unitary component of the body portion. In an example in which the body portion is a multi-piece component, a first component of the body portion can define the inner channel and a second component of the body portion can define the outer channels between the second component and the first component. The first component and the second component can be coupled to one another and/or each of the first and second components can be coupled to the end plate in order to form the anode. Forming the body portion as a multi-piece component can increase manufacturability of the body portion.

In a further example, channels for an inner channel, outer channels, and radial channels can be formed in a body portion of an anode. Inner wall portions can then be coupled to the body portion of the anode. The inner wall portions can at least partially define the inner channels, the outer channels, and/or the radial channels. For example, the inner wall portions can be formed radially between the inner and outer channels, and can form proximal surfaces of the radial channels (e.g., opposite a target surface of the anode). Forming the anode by this method can provide a continuous body portion between the radial channels and the target surface of the anode, which can improve heat dissipation from the target surface to the radial channels. A seam between an end plate and a body portion of the anode can be eliminated relative to other examples, which can improve the durability and longevity of the anode by preventing detachment between the end plate and the body portion. Forming the anode by this method can further improve manufacturability of the anode.

In another example, channels for an inner channel, outer channels, and radial channels can be formed in a body portion of an anode. An outer wall (e.g., a tube or hollow cylinder) can be coupled to the body portion and the outer channels can be defined between the body portion and the outer wall portions. A plug can be coupled to the body portion, and can both reduce a cross-sectional area of the inner channel and direct fluid between the inner channel and the radial channels. Forming the anode by this method can provide a continuous body portion between the radial channels and the target surface of the anode, which can improve heat dissipation from the target surface to the radial channels. A seam between an end plate and a body portion of the anode can be eliminated relative to other examples, which can improve the durability and longevity of the anode by preventing detachment between the end plate and the body portion. Forming the anode by this method can further improve manufacturability of the anode.

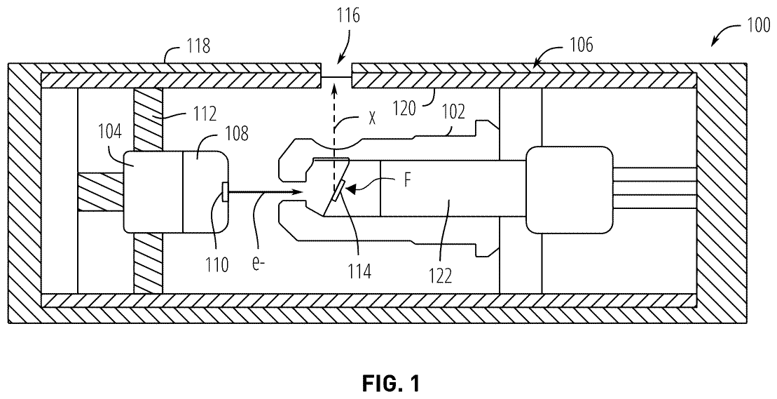

These and other examples are discussed below with reference to FIGS. 1 through 9C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 is a partial section side view of an x-ray tube 100. The x-ray tube 100 can include an anode 102 and a cathode assembly 104 disposed at least partially within an evacuated enclosure 106. The evacuated enclosure 106 can be referred to as an enclosure, a vacuum enclosure, or the like. The x-ray tube 100 illustrated in FIG. 1 is an example of an x-ray tube with a closed-tube configuration. Further, the anode 102 illustrated in FIG. 1 is an example of a stationary anode. However, teachings of the present disclosure can be applied to x-ray tubes with open-tube configurations, with rotating anodes, and the like.

The cathode assembly 104 can include a cathode head 108 and an emitter 110. The cathode assembly 104 can extend from a high-voltage standoff 112, which is disposed on one end of the evacuated enclosure 106. The high-voltage standoff 112 can support the cathode head 108 and the emitter 110 in a desired position relative to the anode 102. The anode 102 (also referred to as an anode assembly) can include a target 114. The anode 102 can extend into the evacuated enclosure 106 opposite the cathode assembly 104. Although FIG. 1 illustrates a stationary anode 102, in some examples, the anode 102 can be a rotating element of an x-ray tube.

The evacuated enclosure 106 can include a window 116 formed in a sidewall thereof. The window 116 can allow x-rays having a prescribed area and characteristics (e.g., wavelengths, energy, and the like) to pass through the window 116, out of the evacuated enclosure 106. The evacuated enclosure 106 can include a housing 118, which can surround an inner enclosure 120. The housing 118 and/or the inner enclosure 120 can define the size, shape, and position of the window 116.

In operation of the x-ray tube 100, electrons are emitted from the emitter 110, which is seated in the cathode head 108. A major emitter surface of the emitter 110 is oriented toward the anode 102. A high voltage potential difference is applied between the emitter 110 and the anode 102, which results in an electron beam (e−) being formed and directed from the emitter 110 towards the anode 102. The electron beam e− can impinge on a focal spot (F) defined on the target 114. Kinetic energy from the electron beam e− can be converted to high energy radiation in the form of x-rays (x) when the electron beam e− contacts the target 114. A portion of the x-rays x can exit the evacuated enclosure 106 through the window 116 in the side of the evacuated enclosure 106. The emerging x-rays can be directed, for example, toward a body of a patient for medical imaging, diagnostics, or radiotherapy; can be directed toward an object of interest for use in non-destructive testing, materials detection and analysis, or security inspection; can be directed to a sample for x-ray irradiation or sterilization; or the like.

Kinetic energy from the electron beam e− that contacts the target 114 can also be converted to heat, which can increase the temperature of the anode 102. Operating the x-ray tube 100 with a higher tube power can increase heat generation from the electron beam e− and can provide corresponding increases to heat dissipation requirements of the anode 102. Allowing the anode 102 to overheat can damage the anode 102 and can render the x-ray tube 100 inoperable. As such, it is desirable to increase heat dissipation provided for the anode 102.

In order to dissipate heat generated at the anode 102, the anode 102 can be provided with an integrated heat exchanger that can be coupled to a cooling system 122. The integrated heat exchanger can include a plurality of channels defined within the anode 102. The channels can flow coolant throughout the anode 102. The channels can include a central or inner channel, peripheral or outer channels, and radial channels that provide fluid communication between the inner and outer channels. The anode 102 can include an inlet and outlet for the coolant to the channels at a proximal end of the anode 102. The radial channels can be provided at a distal end of the anode 102, near the target 114.

A flow direction for the coolant in the inner channel can be opposite to a flow direction for the coolant in the outer channels. In other words, coolant can be supplied to the anode 102 by the cooling system 122 to either the inner channel or the outer channels and can flow through the inner or the outer channels in a first direction. The coolant can flow radially to the other of the inner channel or the outer channels. The coolant can then flow through the other of the inner channel or the outer channels in a second direction opposite the first direction. The coolant can exit the anode 102 from the other of the inner channel or the outer channels into the cooling system 122. The arrangement of the channels in the anode 102 can provide improved cooling throughout the anode 102 and improve heat dissipation in the anode 102. Improving heat dissipation in the anode 102 can allow for higher potential differences to be utilized in the x-ray tube 100, allow the x-ray tube 100 to use higher power, increase durability of the x-ray tube 100, increase longevity of the x-ray tube 100, and the like.

The cooling system 122 can include both an inlet channel that supplies the coolant to the channels of the anode 102, and an outlet channel that removes the coolant from the channels of the anode 102. In some examples, the inlet channel and the outlet channel of the cooling system 122 can be disposed concentric relative to one another (e.g., the inlet channel can be disposed concentrically within the outlet channel, or the outlet channel can be disposed concentrically within the inlet channel). The cooling system 122 can be a space-efficient system to remove heat from the anode 102. The cooling system 122, the anode 102, and the cathode assembly 104 can be disposed at least partially within the evacuated enclosure 106, such that the evacuated enclosure 106 at least partially surrounds the cooling system 122, the anode 102, and the cathode assembly 104.

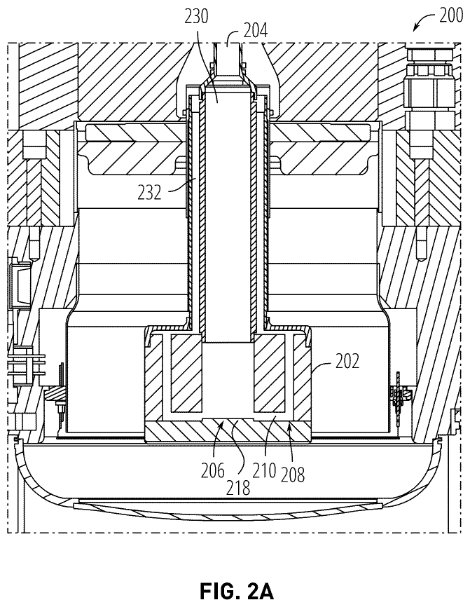

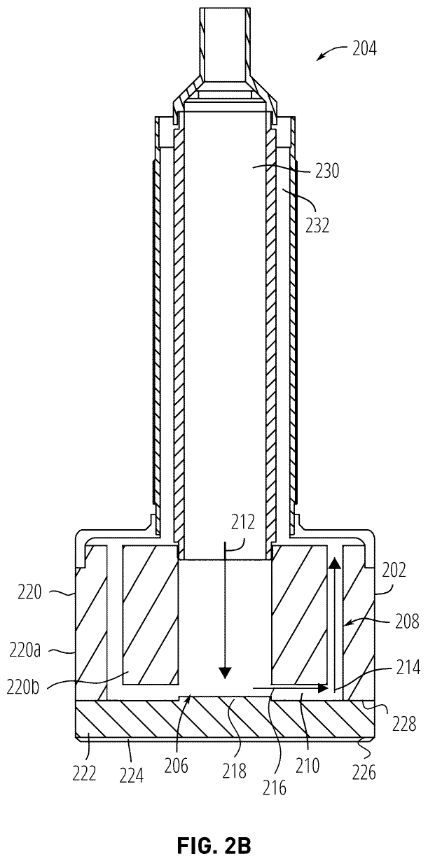

FIG. 2A is a cross-sectional view of an x-ray tube 200 including an anode 202 and a cooling system 204. FIG. 2B is a cross-sectional view of the anode 202 and the cooling system 204. The x-ray tube 200, the anode 202, and the cooling system 204 can be the same as or similar to the x-ray tube 100, the anode 102, and the cooling system 122, respectively, discussed above in reference to FIG. 1. The cooling system 204 can be coupled to the anode 202 and can provide a coolant to the anode 202. The cooling system 204 can be coupled to a proximal end of the anode 202 opposite a distal end of the anode 202 to which a target 224 is coupled.

The anode 202 can include a plurality of channels, which are configured to direct a coolant through the anode 202. For example, the anode 202 can include an inner channel 206 that can be configured to flow coolant in a first direction 212, as shown in FIG. 2B. The anode 202 can include outer channels 208 configured to flow the coolant in a second direction 214 opposite the first direction 212, as shown in FIG. 2B. The anode 202 can further include radial channels 210 that can be in fluid communication with the inner channel 206 and the outer channels 208. The radial channels 210 can direct the coolant in a radial direction 216 from the inner channel 206 to the outer channels 208 (e.g., radially outward). In some examples, the coolant can flow in the opposite direction (e.g., opposite the first direction 212 in the inner channel 206, opposite the second direction 214 in the outer channels 208, and opposite the radial direction 216 in the radial channels 210). Although a single inner channel 206, two outer channels 208, and two radial channels 210 are illustrated in the cross-sectional views of FIG. 2A and FIG. 2B, any number of inner channels, outer channels, and radial channels can be provided in the anode 202.

The anode 202 can include various features for directing flow of the coolant through the anode 202. For example, as illustrates in FIGS. 2A and 2B, the anode 202 can include a protrusion 218. The protrusion 218 can direct flow of the coolant from the inner channel 206 to the radial channels 210 or the like. In some examples, the protrusion 218 can have a greater length than illustrated in FIGS. 2A and 2B. The protrusion 218 can be used to decrease a cross-sectional area of the inner channel 206, and can increase a velocity of coolant through the inner channel 206. Additional protrusions, angled features, or the like can be included in the anode 202 to direct fluid flow through the anode 202. For example, angled features can be included at interfaces between the radial channels 210 and the outer channels 208 to direct the coolant between the radial channels 210 and the outer channels 208.

In some examples, an area of flow or a cross-sectional area in each of the channels 206, 208, 210 can be the same or similar. For example, a cross-sectional area of the inner channel 206 perpendicular to the first direction 212 can be equal to combined cross-sectional areas of the outer channels 208 perpendicular to the second direction 214 and combined cross-sectional areas of the radial channels 210 perpendicular to the radial direction 216. The flow area of the inner channel 206 can be within a prescribed range of the combined flow area of the outer channels 208 and within the prescribed range of the combined flow areas of the radial channels 210. The prescribed range can be about 5%, about 10%, about 15%, about 20%, or the like. This can be used to reduce pressure drop through the channels 206, 208, 210. This can reduce a size of a pump used to supply coolant to the anode 202, reduce wear-and-tear on said pump, and increase the longevity of said pump. Providing the prescribed cross-sectional areas of the channels 206, 208, 210 can also be used to alter flow characteristics of the coolant through the anode 202, such as by preventing turbulence within the channels 206, 208, 210, can improve cooling provided by the channels 206, 208, 210, improve durability of the anode 202, and the like.

In the example of FIGS. 2A and 2B, the anode 202 can be formed from one or more parts or components. For example, the anode 202 can be formed from a body portion 220 and an end plate 222 (alternatively referred to as an end cap) coupled to the body portion 220. The body portion 220 can be a single-piece or unitary component (e.g., such that the anode 202 is a two-part component) or can include a first portion 220a and a second portion 220b (e.g., such that the anode 202 is a three-part component). The anode 202 (e.g., the body portion 220 and the end plate 222) can be formed from materials having high heat transfer coefficients, such as metals. In some examples, the anode 202 can include copper, molybdenum, tungsten, silver, gold, steel, alloys thereof, graphite (e.g., anodic graphite), or the like.

The anode 202 can be constructed by providing the body portion 220 and the end plate 222 and coupling the end plate 222 to the body portion 220. The end plate 222 can be coupled to the body portion 220 by any suitable means, such as brazing, fasteners, clips, glues, threads, welding, soldering, or the like. In examples in which the body portion 220 includes multiple components (e.g., the first portion 220a and the second portion 220b), the components of the body portion 220 can be coupled to one another or can each be coupled to the end plate 222. The channels 206, 208, 210 can be formed in the body portion 220 and/or the end plate 222 by subtractive manufacturing methods, such as milling, turning, drilling, boring, reaming, water jet machining, or the like. Forming the anode 202 as a two-part or three-part component can allow for the radial channels 210 to be formed adjacent to the end plate 222, and can reduce manufacturing processes, costs, and time for forming the anode 202. Although the anode 202 has been described as being formed by various subtractive manufacturing processes, in some examples, the anode 202 or components thereof (e.g., the body portion 220 and/or the end plate 222) can be formed by additive manufacturing processes, such as 3D printing, casting, or the like.

The anode 202 can include a target 224, which can be coupled to the end plate 222 opposite the cooling system 204 and the body portion 220. The target 224 is an x-ray target, which can be used to generate x-rays in response to an incident electron beam. The target 224 can be formed from a metal having a high atomic number and a high melting point, such as tungsten, molybdenum, rhodium, or an alloy thereof.

The target 224 can be coupled to a first surface 226 of the end plate 222, and the channels 206, 208, and/or 210 can be at least partially defined by a second surface 228 of the end plate 222 opposite the first surface 226. An electron beam directed at the target 224 can heat the target 224 such that the anode 202 can have a high temperature (e.g., a maximum temperature) at the end plate 222, adjacent to the target 224. By providing coolant flow to surfaces of the end plate 222, heat dissipation from the anode 202 to the coolant can be increased and the anode 202 can be cooled more effectively. By forming the anode 202 as a multi-piece component or by an additive manufacturing method, the radial channels 210 can be formed at the distal end of the anode 202, adjacent to the target 224 through a simplified manufacturing process.

A thickness of the end plate 222 can be selected in order to optimize heat transfer from the anode 202 and to improve durability of the anode 202. For example, the end plate 222 can have a thickness in a range from about 0.2 inches to about 0.5 inches, in a range from about 0.1 inches to about 0.75 inches, in a range from about 0.3 inches to about 0.5 inches, in a range from about 0.45 inches to about 0.55 inches, about 0.5 inches, about 0.4 inches, or the like. Increasing the thickness of the end plate 222 can improve durability of the anode 202. Providing the end plate 222 with a thickness within the prescribed ranges can optimize heat transfer both laterally across the end plate 222 (e.g., in a direction parallel to a longitudinal axis and diameter of the end plate 222) and vertically through the end plate 222 (e.g., between the first surface 226 and the second surface 228 of the end plate 222).

The cooling system 204 can be provided to supply coolant to and receive coolant from the anode 202. The cooling system 204 can be coupled to the anode 202 by any suitable means, such as brazing, fasteners, clips, glues, threads, welding, soldering, or the like. The cooling system 204 can be used to supply any suitable coolant to the anode 202, such as water, ethylene glycol, silicone-based polymers, other glycol or silicone-based coolants, oil-based coolants, or any other coolants. The cooling system 204 can include a coolant inlet 230 and a coolant outlet 232. The coolant outlet 232 can be arranged concentric with the coolant inlet 230. For example, the coolant inlet 230 and the coolant outlet 232 can be concentric cylinders with the coolant inlet 230 being arranged within the coolant outlet 232, as shown in FIGS. 2A and 2B. The coolant inlet 230 and the coolant outlet 232 can have any desired shapes, such as circular, round, square, rectangular, triangular, other polygonal, or other shapes in a cross-sectional view. The shape of the coolant inlet 230 and the coolant outlet 232 can mirror or match the shape of the anode 202. In some examples, the coolant inlet 230 and the coolant outlet 232 can be concentric cuboids, concentric truncated cones, or the like.

The coolant inlet 230 can be configured to direct coolant to the inner channel 206. The body portion 220 of the anode 202 can then direct the coolant from the inner channel 206, radially outward through the radial channels 210, and into the outer channels 208. The outer channels 208 can then direct the coolant to the coolant outlet 232 of the cooling system 204. In some examples, the direction of flow of the coolant can be reversed such that the coolant outlet is defined within the coolant inlet. In such examples, the coolant inlet can be configured to direct coolant into the outer channels 208, radially inward through the radial channels 210, and into the inner channel 206. The inner channel 206 can then direct the coolant to the coolant outlet of the cooling system 204. In some examples, the cooling system 204 (e.g., the tubes or components that define the coolant inlet 230 and the coolant outlet 232) can be formed from metals, such as aluminum, steel (e.g., stainless steel), alloys thereof, or the like. The cooling system 204 can be sealed to the channels of the anode 202 (e.g., with watertight seals). For example, the coolant inlet 230 can be sealed to the inner channel 206 and the coolant outlet 232 can be sealed to the outer channels 208.

In the example of FIG. 2A and FIG. 2B, coolant supplied by the cooling system 204 enters the anode 202 through the coolant inlet 230, flows through the length of the anode 202, moves radially, and flows back through the length of the anode 202 and flows out of the coolant outlet 232. Heat can be transferred from the anode 202 to the coolant throughout the flow path of the coolant. The arrangement of the channels 206, 208, 210 in the anode 202 can provide improved cooling throughout the anode 202 and improve heat dissipation in the anode 202. Improving heat dissipation in the anode 202 can allow for higher potential differences to be utilized in the x-ray tube 200, allow the x-ray tube 200 to use higher power, increase durability of the x-ray tube 200, increase longevity of the x-ray tube 200, and the like.

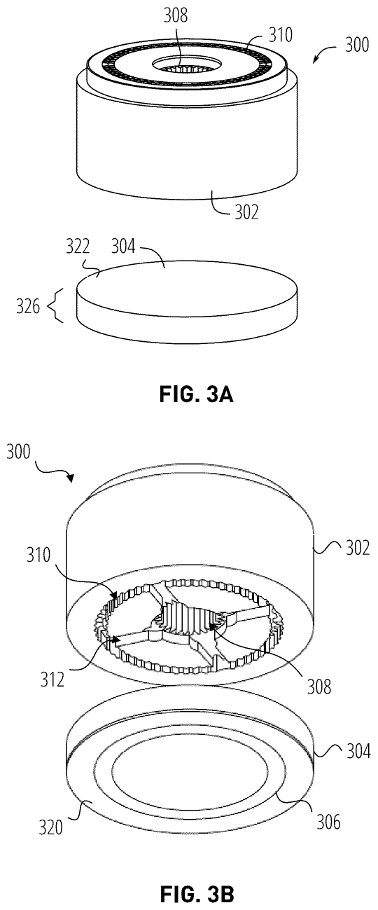

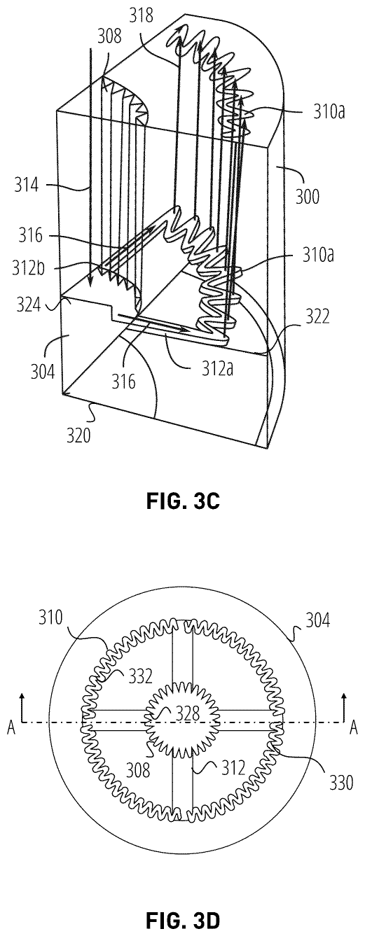

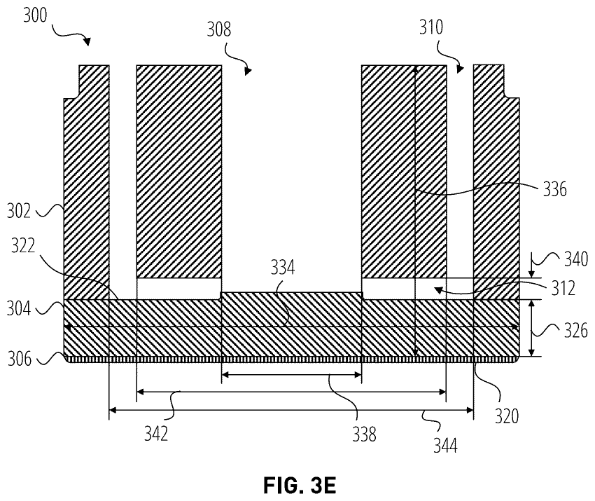

FIGS. 3A through 3E illustrate various views of an anode 300. The anode 300 can be the same as or similar to the anodes 102, 202, discussed above in reference to FIGS. 1 through 2B. FIG. 3A is a top isometric exploded view of the anode 300. FIG. 3B is a bottom isometric exploded view of the anode 300. FIG. 3C is a partial perspective section view of a portion of the anode 300. FIG. 3D is a bottom-up view of a body portion 302 of the anode 300. FIG. 3E is a cross-sectional view of the anode 300 along reference line A-A illustrated in FIG. 3D.

The anode 300 can be used in an x-ray tube to generate x-rays. The anode 300 can include a body portion 302 and an end plate 304. A target 306 can be coupled to the end plate 304. The target 306 can be an x-ray target or target layer, which can generate x-rays when exposed to an electron beam. Energy from the electron beam incident on the target 306 (and/or the end plate 304) can generate heat in the anode 300, raising the temperature of the anode 300, which can damage the anode 300 and render the x-ray tube inoperable. An integrated heat exchanger can be included within the anode 300 to dissipate heat from the anode 300, preventing overheating of the anode 300. This can allow for the anode 300 to be used in an x-ray tube with higher power, with higher potential differences between a cathode and the anode 300, and can increase the durability and longevity of the anode 300.

The body portion 302 can be coupled to the end plate 304 and the target 306 can be coupled to the end plate 304 through any suitable means. For example, the body portion 302 can be coupled to the end plate 304 and the target 306 can be coupled to the end plate 304 by brazing, welding, metal-to-metal bonding techniques, or any other suitable joining techniques. The end plate 304 and the body portion 302 can be made of metals, such as copper, tungsten, silver, steel, alloys thereof; graphite (e.g., anodic graphite); or the like. The target 306 can be formed from a metal having a high atomic number and a high melting point, such as tungsten or an alloy thereof.

The integrated heat exchanger in the anode 300 can include channels defined by the body portion 302 and the end plate 304. The channels defined in the anode 300 can include an inner channel 308, outer channels 310, and radial channels 312. In the example illustrated in FIGS. 3A through 3D, the anode 300 includes one inner channel 308, four outer channels 310, and four radial channels 312. However, more or fewer channels can be included in each of the channels 308, 310, 312, and the number of channels and configuration of the channels can be used to maximize heat dissipation from the anode 300, durability of the anode 300, and manufacturability of the anode 300. The outer channels 310 can at least partially encircle or surround the radial channels 312 and the inner channel 308.

The inner channel 308 can have a flow area approximately or substantially equal to a combined flow area of the outer channels 310 and a combined flow area of the radial channels 312. The flow area of each of the channels 308, 310, 312 can be determined in a plane perpendicular to flow through the respective channel. A combined flow area for the outer channels 310 can be determined by adding respective flow areas for each of the outer channels 310 together. A combined flow area for the radial channels 312 can be determined by adding respective flow areas for each of the radial channels 312 together. The flow area of the inner channel 308 can be within about 5%, about 10%, about 15%, or the like of the combined flow area of the outer channels 310 and combined flow areas of the radial channels 312. This can be used to alter flow characteristics of the coolant through the anode 300, such as by preventing turbulence within the channels 308, 310, 312, and can improve cooling provided by the channels 308, 310, 312, improve durability of the anode 300, and the like.

The inner channel 308 and the outer channels 310 can be defined within the body portion 302. Portions of the inner channel 308 and the outer channels 310 (e.g., end surfaces adjacent the radial channels 312) can be at least partially defined by the end plate 304. The radial channels 312 can be defined by and between the body portion 302 and the end plate 304. The target 306 can be coupled to a first surface 320 of the end plate 304 (e.g., an outer surface of the end plate 304) and the radial channels 312 can direct coolant along and be defined adjacent to a second surface 322 of the end plate 304 (e.g., an inner surface of the end plate 304) opposite the first surface 320. An electron beam incident to the target 306 and/or the end plate 304 can generate heat at the end plate 304 such that a maximum temperature of the anode 300 is at or near the first surface 320 of the end plate 304 and the target 306. By flowing coolant along surfaces of the end plate 304, heat dissipation from the anode 300 to the coolant can be increased and the anode 300 can be cooled more effectively.

A thickness 326 of the end plate 304 can be selected in order to optimize heat transfer from the anode 300 and to improve durability of the anode 300. For example, the end plate 304 can have a thickness 326 in a range from about 0.2 inches to about 0.5 inches, in a range from about 0.1 inches to about 0.75 inches, in a range from about 0.3 inches to about 0.5 inches, in a range from about 0.45 inches to about 0.55 inches, about 0.5 inches, about 0.4 inches, or the like. Increasing the thickness 326 of the end plate 304 can improve durability of the anode 300. Providing the end plate 304 with a thickness 326 within the prescribed ranges can optimize heat transfer both laterally across the end plate 304 (e.g., in a direction parallel to a longitudinal axis and diameter of the end plate 304) and vertically through the end plate 304 (e.g., between the first surface 320 and the second surface 322 of the end plate 304).

FIG. 3C shows an illustrative flow path for coolant through the channels 308, 310, 312 according to some examples. The coolant can enter the body portion 302 in the inner channel 308 and can flow through the inner channel 308 in a first direction 314. The coolant can then exit the inner channel 308 and move into the radial channels 312. In the section view of FIG. 3C, the coolant is illustrated as moving into two of the radial channels 312, a first radial channel 312a and a second radial channel 312b The coolant can flow through the radial channels 312 in a second direction 316 (also referred to as a radial direction), which can be perpendicular to the first direction 314 and parallel to a longitudinal axis of the end plate 304 and major surfaces of the end plate 304. The coolant can then move from the radial channels 312a, 312b into a first outer channel 310a of the outer channels 310. The coolant can flow through the outer channels 310 in a third direction 318, which can be parallel to and opposite the first direction 314 and perpendicular to the second direction 316. In the example of FIGS. 3A through 3D, the inner channel 308 can flow into four radial channels 312. Each of the radial channels 312 can flow into two outer channels 310. In some examples, the flow direction through each of the channels 308, 310, 312 can be reversed. The body portion 302 and/or the end plate 304 can include protrusions, angled surfaces, or the like in order to aid in directed fluid flow through the anode 300. For example, the end plate 304 can include a protrusion 324, which can aid in directed fluid flow between the inner channel 308 and the outer channels 310.

FIG. 3D is a bottom-up view of the body portion 302 of the anode 300 without the end plate 304. As illustrated in FIG. 3D, the inner channel 308 can be fluidly coupled to four radial channels 312. Each of the radial channels 312 can be fluidly coupled to two outer channels 310. The number of inner channels 308, radial channels 312, and outer channels 310 can be selected to increase surface area between the anode 300 and coolant flowing through the channels 308, 310, 312, which can increase heat dissipation from the anode 300 to the coolant flowing through the channels 308, 310, 312. Positions of the channels 308, 310, 312 relative to the anode 300 can be selected to improve heat dissipation across the end plate 304. For example, by including the radial channels 312 and the outer channels 310, heat transfer across the diameter of the end plate 304 is increased. This provides cooling for the entire diameter of the end plate 304, including outer edges of the end plate 304.

Any of the channels 308, 310, 312 can include extended surfaces, which can be used to increase surface area of the channels 308, 310, 312, and increase heat dissipation from the anode 300. For example, as illustrated in FIG. 3D, the inner channel 308 can include extended surfaces 328 and the outer channels 310 can include inner extended surfaces 330 that project away from the inner channel 308 and outer extended surfaces 332 the project towards the inner channel 308. The extended surfaces 328 can be portions of the anode 300 (e.g., the body portion 302) that extend into the inner channel 308. The inner extended surfaces 330 can be portions of the anode 300 (e.g., the body portion 302) that extend into the outer channels 310. The outer extended surfaces 332 can be portions of the anode 300 (e.g., the body portion 302) that extend into the outer channels 310. The extended surfaces 328, 330, 332 can be extensions of the body portion 302, which can be used to increase the surface of the body portion 302 and increase the heat transfer rate from the anode 300 to the coolant. FIG. 3D illustrates the extended surfaces 328, 330, 332 as fins; however, the extended surfaces 328, 330, 332 can include any surface profiles or characteristics that increase a surface area between the channels 308, 310, 312 and the anode 300. For example, the extended surfaces 328, 330, 332 can include fins, textured surfaces, porous surfaces (e.g., porous media), or the like. The extended surfaces 328, 330, 332 can be straight extended surfaces (e.g., fins) with uniform cross-sections, or can have varied cross-sectional profiles. In examples in which the extended surfaces 328, 330, 332 are fins, the extended surfaces 328, 330, 332 can be V-shaped, U-shaped, triangular, or have any other suitable cross-sectional shape.

As illustrated in FIG. 3D, in a cross-sectional or bottom-up view, the inner channel 308 can have a circular shape with the extended surfaces 328 extending therefrom. The radial channels 312 can be rectangular. The outer channels 310 can each define a portion of an annular ring. The inner extended surfaces 330 and the outer extended surfaces 332 can be offset from one another, such that the outer channels 310 have a repeating W shape. However, any suitable shapes can be used for the channels 308, 310, 312. For example, the radial channels 312 can have rounded, trapezoidal, or other cross-sectional shapes. The outer channels 310 can have circular or other cross-sectional shapes. Any of the channels 308, 310, 312 can zigzag, have baffles, or the like to increase a surface area of the anode 300 in contact with the coolant.

FIG. 3E is a cross-sectional view of the anode 300 and illustrates various dimensions of the anode 300. The anode 300 can have a diameter 334 in a range from about 2 inches to about 4 inches, from about 2.5 inches to about 3.9 inches, from about 3 inches to about 3.5 inches, or the like. The anode 300 can have a height 336 between the first surface 320 of the end plate 304 and a surface of the body portion 302 opposite the end plate 304.

The height 336 can be in a range from about 1 inch to about 2 inches, from about 1.2 inches to about 2 inches, from about 1.3 inches to about 2 inches, from about 1.5 inches to about 1.8 inches, or the like. The inner channel 308 can have a diameter 338 in a range from about 0.4 inches to about 1 inch, from about 0.7 inches to about 1.1 inches, from about 0.5 inches to about 0.85 inches, or the like. A cross-sectional area of the inner channel 308 (e.g., a flow area of the inner channel 308) can be in a range from about 0.1 in² to about 0.4 in², in a range from about 0.2 in² to about 0.3 in², about 0.36 in², or the like.

The radial channels 312 can have diameters 340 in a range from about 0.2 inches to about 0.3 inches, from about 0.25 inches to about 0.45 inches, or the like. In the example of FIGS. 3A through 3E, the anode 300 includes 4 radial channels 312; however, any suitable number of the radial channels 312, such as a greater or fewer number than 4 radial channels 312, can be included in the anode 300. In examples in which a greater or fewer number of the radial channels 312 are provided, the diameters 340 of the radial channels 312 can be decreased or increased, respectively, to provide about the same cross-sectional area in the radial channels 312 as the inner channel 308 and the outer channels 310. A cross-sectional area of the radial channels 312 (e.g., a combined flow area of the radial channels 312) can be in a range from about 0.3 in² to about 0.5 in², in a range from about 0.35 in² to about 0.45 in², about 0.39 in², or the like.

An inner diameter 342 of the outer channels 310 can be in a range from about 2.25 inches to about 3.5 inches, from about 2.5 inches to about 3.25 inches, or the like. An outer diameter 344 of the outer channels 310 can be in a range from about 2.3 inches to about 3.6 inches, from about 2.6 inches to about 3.3 inches, or the like. A cross-sectional area of the outer channels 310 (e.g., a combined flow area of the outer channels 310) can be in a range from about 0.1 in² to about 0.5 in², in a range from about 0.2 in² to about 0.4 in², about 0.23 in², or the like. The inner channel 308 can have a cross-sectional area equal to or greater than the outer channels 310, which can maximize heat transfer in the outer channels 310.

Specifically, a velocity of coolant in the outer channels 310 can be equal to or greater than a velocity of coolant in the inner channel 308, which can increase heat transfer in the outer channels 310. The outer channels 310 can be adjacent to areas of the anode 300 having the highest temperatures, and this can increase heat dissipation for the anode 300, while also minimizing pressure drop through the anode 300.

The dimensions of the anode 300 can be scaled in order to use the anode 300 for various applications, which can use anodes of different dimensions. In such cases, providing various ratios between dimensions of the anode 300 can help to ensure that the anode 300 provides efficient cooling, while having good durability and manufacturability. For example, a ratio between the outer diameters 344 of the outer channels 310 and the diameter 334 of the anode 300 can be in a range from about 0.8 to about 0.95, about 0.9, or the like. The ratio between the outer diameters 344 of the outer channels 310 and the diameter 334 of the anode 300 can determine the radial location of the outer channels 310 relative to the anode 300, and can be selected based on a location of the target 306, a location of a maximum temperature on the anode 300, and the like. A ratio between the diameter 338 of the inner channel 308 and the diameter 334 of the anode 300 can be in a range from about 0.15 to about 0.35, in a range from about 0.1 to about 0.3, about 0.27, about 0.21, or the like. Increasing the height 336 of the anode 300 can increase cooling in the anode 300 in a relatively linear manner such that a power capacity for an x-ray tube including the anode 300 can increase relatively linearly. For example, a ratio of maximum power capacity for an x-ray tube to the height 336 can be in a range from about 9 kW/inch to about 12 kW/in, about 9.64 kW/inch, or the like.

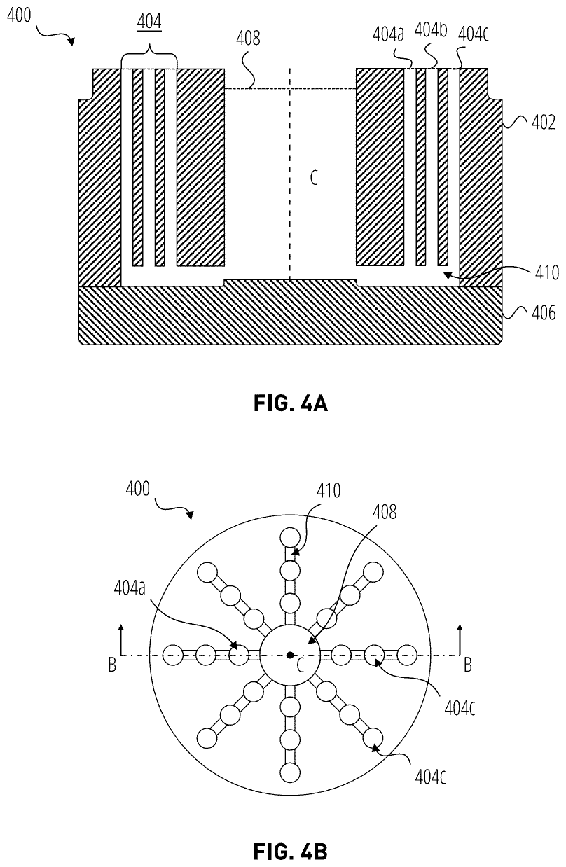

FIGS. 4A and 4B illustrate an example of an anode 400 that includes a body portion 402 with outer channels 404 disposed at different radial distances in the body portion 402. FIG. 4A illustrates a cross-sectional view of the anode 400 along reference line B-B illustrated in FIG. 4B and FIG. 4B illustrates a bottom-up view of the body portion 402 of the anode 400. The anode 400 can be the same as or similar to the anodes 102, 202, 300, discussed above with respect to FIGS. 1 through 3D, except that the anode 400 includes a different arrangement of channels therein. For example, the anode 400 can include the body portion 402 and an end plate 406 coupled to the body portion 402. A target (not separately illustrated) can be coupled to the end plate 406 and the anode 400 can be exposed to an electron beam to produce x-rays.

As illustrated in FIGS. 4A and 4B, the anode 400 can include an inner channel 408, radial channels 410, and the outer channels 404. The channels 404, 408, 410 can be defined by the body portion 402 and/or the end plate 406. For example, the inner channel 408 and the outer channels 404 can extend through the body portion 402 and the radial channels 410 can be defined by the body portion 402 and the end plate 406. As illustrated in FIGS. 4A and 4B, the outer channels 404 can include first outer channels 404a defined at a first radial distance in the body portion 402, second outer channels 404b defined at a second radial distance in the body portion 402 greater than the first radial distance, and third outer channels 404c defined at a third radial distance in the body portion 402 greater than the second radial distance. The radial distances can be measured from a center point C of the body portion 402 of the anode 400. The second outer channels 404b can be between the first outer channels 404a and the third outer channels 404c. Although the outer channels 404 are illustrated as including channels at three radial distances, any number of channels disposed at any desired radial distance can be included. The outer channels 404 can at least partially encircle or surround the radial channels 410 and the inner channel 408. The third outer channels 404c can at least partially encircle or surround the second outer channels 404b and the first outer channels 404a. The second outer channels 404b can at least partially encircle or surround the first outer channels 404a.

The radial channels 410 can be provided to direct coolant between the inner channel 408 and the outer channels 404. In the example illustrated in FIGS. 4A and 4B, the anode 400 includes eight radial channels 410 that are each fluidly coupled to the inner channel 408 and a first outer channel 404a, a second outer channel 404b, and a third outer channel 404c. However, any number of radial channels 410 can be included and can be coupled to any number of outer channels 404 and inner channels 408.

By providing the outer channels 404 at different radial distances, heat dissipation can be provided throughout the volume of the anode 400. Specifically, the outer channels 404 can be provided at selected radial distances in order to provide improved heat dissipation to specific portions of the anode 400. In some examples, the outer channels 404 can be provided at locations overlapping locations on the anode 400 that an electron beam is configured to impinge. The configuration of FIGS. 4A and 4B can allow for the anode 400 to be used in an x-ray tube with higher power, with higher potential differences between a cathode and the anode 400 and can increase the durability and longevity of the anode 400.

The inner channel 408 can have a flow area approximately or substantially equal to a combined flow area of the outer channels 404 and a combined flow area of the radial channels 410. The flow area of each of the channels 404, 408, 410 can be determined in a plane perpendicular to flow through the respective channel. A combined flow area for the outer channels 404 can be determined by adding respective flow areas for each of the outer channels 404 together. A combined flow area for the radial channels 410 can be determined by adding respective flow areas for each of the radial channels 410 together. The flow area of the inner channel 408 can be within about 5%, about 10%, about 15%, or the like of the combined flow area of the outer channels 404 and combined flow area of the radial channels 410. This can be used to alter flow characteristics of the coolant through the anode 400, such as by preventing turbulence within the channels 404, 408, 410, and can improve cooling provided by the channels 404, 408, 410, improve durability of the anode 400, and the like.

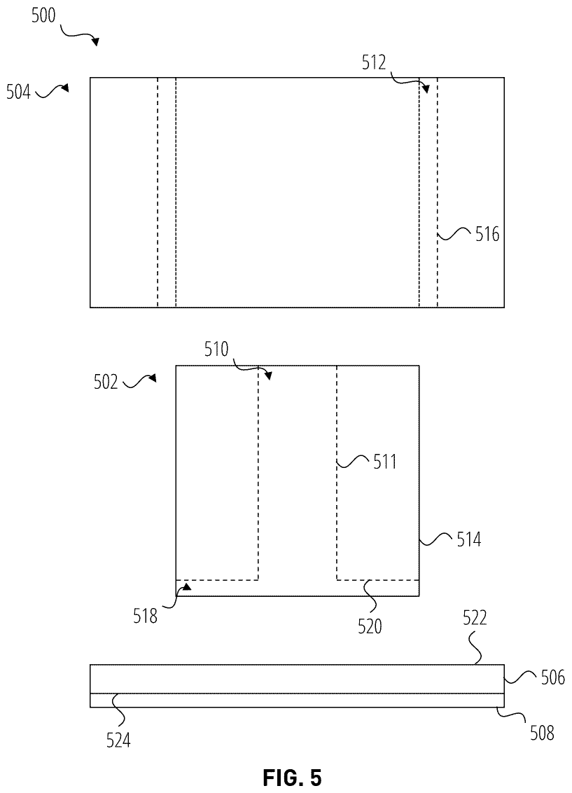

FIG. 5 is an exploded view of an anode 500. The anode 500 can be a three-part component, and can include a first body portion 502, a second body portion 504, and an end plate 506. The anode 500 can be the same as or similar to the anodes 102, 202, 300, 400, discussed above with respect to FIGS. 1 through 4B, except that the anode 500 is a three-part component. Forming the anode 500 as a three-part component can simplify manufacturing processes used to form the anode 500 and can reduce the cost to produce the anode 500.

As illustrated by FIG. 5, the first body portion 502 and the second body portion 504 can be arranged concentrically with one another, with the second body portion 504 encircling the first body portion 502. In some examples, the first body portion 502 and the second body portion 504 can be coupled to one another. At least one of the first body portion 502 or the second body portion 504 can be coupled to the end plate 506. A target 508 (e.g., an x-ray target or a target layer) can be coupled to an outer surface 524 of the end plate 506 opposite the first body portion 502 and the second body portion 504. The first body portion 502, the second body portion 504, the end plate 506, and the target 508 can be coupled to one another through any suitable means, such as brazing, fasteners, clips, glues, threads, welding, soldering, or the like.

Channels can be formed in the anode 500 and defined by the first body portion 502, the second body portion 504, and the end plate 506. For example, an inner channel 510 can be formed within and defined by the first body portion 502. The inner channel 510 can be defined by an inner surface of the first body portion 502. Outer channels 512 can be formed between an outer surface 514 of the first body portion 502 and an inner surface 516 of the second body portion 504. The outer channels 512 can be defined by both the first body portion 502 and the second body portion 504. Radial channels 518 can be formed between a distal surface 520 of the first body portion 502 and an inner surface 522 of the end plate 506. The radial channels 518 can be defined by both the first body portion 502 and the end plate 506. The radial channels 518 can be defined by machining channels in the 502 and/or the end plate 506 and coupling the end plate 506 to the first body portion 502. The outer channels 512 can at least partially encircle or surround the radial channels 518 and the inner channel 510.

In some examples, extended surfaces can be formed in the inner surface 511 of the first body portion 502, the outer surface 514 of the first body portion 502, the inner surface 516 of the second body portion 504, and any surfaces that define the radial channels 518. The extended surfaces can increase a surface area of the anode 500 that contacts a coolant and increase heat transfer between the anode 500 and the coolant.

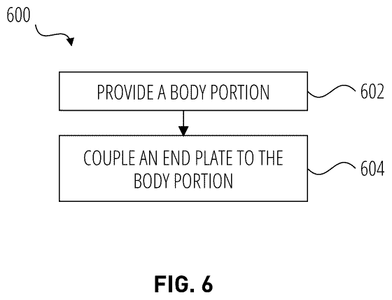

FIG. 6 illustrates flowchart of a method 600 for manufacturing an anode. The method 600 can be used to manufacture any of the anodes 102, 202, 300, 400, 500, discussed above with respect to FIGS. 1 through 5. The method 600 can include a block 602 in which a body portion of an anode is provided and a block 604 in which an end plate is coupled to the body portion in order to form the anode.

In block 602, the body portion is provided. The body portion can be formed from copper, tungsten, silver, steel, alloys thereof, graphite (e.g., anodic graphite), or the like. As discussed above, the body portion can be a one-part (e.g., unitary) component, a multi-part (e.g., a two-part) component, or the like. The body portion can include outer channels and inner channels. Radial channels that can fluidly couple the outer channels with the inner channels can be provided in the body portion or the end plate of the anode. The body portion can be formed from additive and/or subtractive manufacturing processes, including 3D printing, casting, milling, turning, drilling, boring, reaming, water jet machining, or the like.

In examples in which the body portion is a unitary component, the outer channels, the inner channels, and optionally the radial channels can be defined in the body portion through subtractive manufacturing processes, such as milling, turning, drilling, boring, reaming, water jet machining, or the like. In examples in which the body portion is a multi-piece component, the body portion can include a first body portion and a second body portion. The first body portion and the second body portion can be arranged concentrically with one another such that the second body portion encircles or surrounds the first body portion. In some examples, the first and second body portions can be formed by subtractive manufacturing methods, such as milling, turning, drilling, boring, reaming, water jet machining, or the like. In some examples, the first and second body portions can be pipes, which can be formed through conventional processes. This can reduce manufacturing costs and time for forming the anode and can use conventional manufacturing equipment. The first and second body portions can optionally be coupled to one another by any suitable means, such as brazing, fasteners, clips, glues, threads, welding, soldering, or the like.

In block 604, the end plate is coupled to the body portion to form the anode. The end plate can be formed from copper, tungsten, silver, steel, alloys thereof, graphite (e.g., anodic graphite), or the like. The end plate can be coupled to the body portion by any suitable means, such as brazing, fasteners, clips, glues, threads, welding, soldering, or the like. In examples in which the body portion includes a first body portion and a second body portion (e.g., the body portion is a multi-part component), the end plate can be coupled to the first body portion and/or the second body portion. In some examples, the radial channels can be formed in the end plate through subtractive manufacturing processes, such as milling, turning, drilling, boring, reaming, water jet machining, or the like.

The end plate can be coupled to the body portion such that the radial channels are disposed between the end plate and the body portion. A surface of the end plate opposite a target surface of the anode can at least partially define the radial channels. As a result, the radial channels can be disposed at a distal end of the anode opposite a proximal end of the anode through which coolant can be supplied to and exit from the anode. This provides a heat transfer path throughout the thickness of the anode and across a surface (e.g., a target surface) of the anode, improving heat dissipation throughout the volume of the anode.

By forming the anode as a two-part or a three-part component, the radial channels can be defined between the end plate and the body portion. This allows coolant to flow across a surface of the end plate proximal a target surface of the anode, which can be a location of a maximum temperature in the anode. This improves heat dissipation from the anode, which improves durability and longevity of the anode. Moreover, the anode can be formed by conventional manufacturing processes with low cost.

In some examples, the method 600 can further include coupling a target (e.g., an x-ray target or target layer) to the end plate. The target can be formed from a metal having a high atomic number and a high melting point, such as tungsten or an alloy thereof. The target can be coupled to the end plate by any suitable means, such as brazing, fasteners, clips, glues, threads, welding, soldering, or the like.

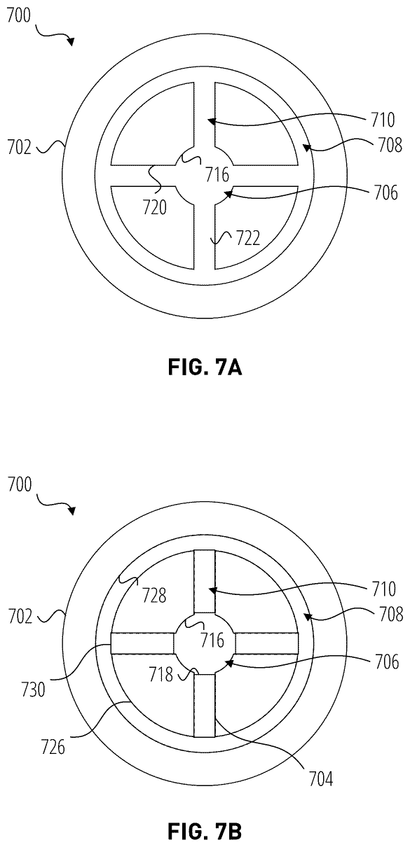

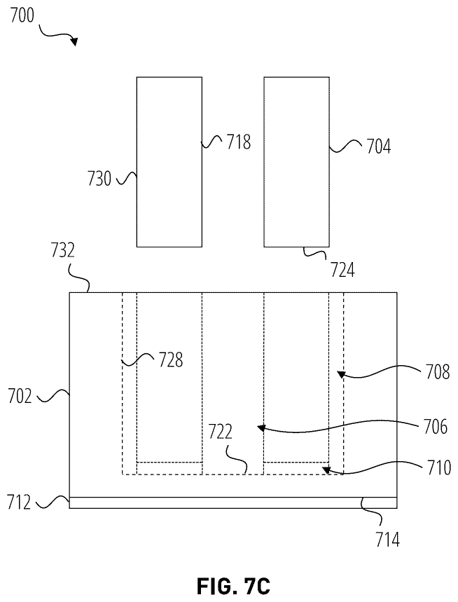

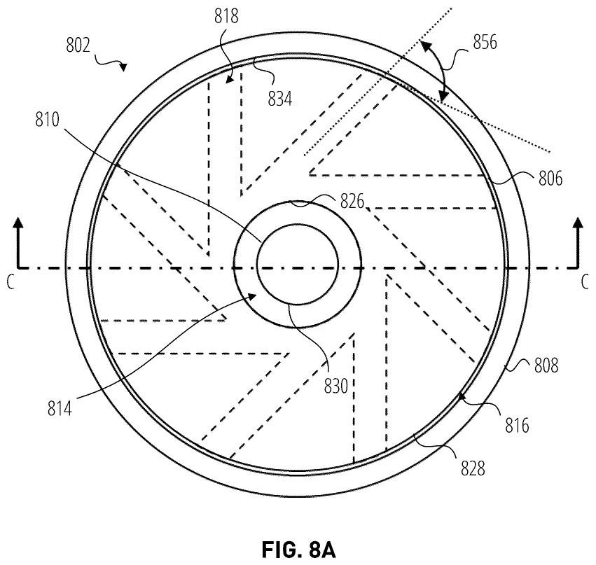

FIGS. 7A through 7C illustrate an example of an anode 700 that includes a body portion 702 and inner walls 704. The inner walls 704 can at least partially define an inner channel 706, an outer channel 708, and radial channels 710. FIG. 7A illustrates a top-down view of the anode 700 without the inner walls 704, FIG. 7B illustrates a top-down view of the anode 700 with the inner walls 704, and FIG. 7C illustrates an exploded view of the anode 700. The anode 700 can be the same as or similar to any of the anodes 102, 202, 300, 400, 500, discussed above with respect to FIGS. 1 through 5, except that the anode 700 can be formed by a different process. The processes used to form the anode 700 can be used to form the anodes 102, 202, 300, 400, 500.

The anode 700 can be formed by providing the body portion 702. Channels for the inner channel 706, the outer channel 708, and the radial channels 710 can be formed in the body portion 702 by subtractive manufacturing methods, such as milling, turning, drilling, boring, reaming, water jet machining, or the like. The inner walls 704 can be inserted into and coupled to the body portion 702. The inner walls 704 can be coupled to the body portion 702 through any suitable means, such as brazing, fasteners, clips, glues, threads, welding, soldering, or the like. A target 712 (e.g., an x-ray target or a target layer) can be coupled to an outer surface 714 of the body portion 702. The target 712 can be coupled to the body portion 702 through any suitable means, such as brazing, fasteners, clips, glues, threads, welding, soldering, or the like.

Surfaces of the body portion 702 and the inner walls 704 can define the inner channel 706, the outer channel 708, and the radial channels 710. For example, surfaces of the body portion 702 (e.g., inward-facing circumferential surfaces 716 of the body portion 702) and the inner walls 704 (e.g., inward-facing surfaces 718 of the inner walls 704) can define the inner channel 706. Surfaces of the body portion 702 (e.g., radial surfaces 720 of the body portion 702 and inner surfaces 722 of the body portion 702 opposite outer surfaces 714) and the inner walls 704 (e.g., surfaces 724 of the inner walls 704 facing the inner surfaces 722 of the body portion 702) can define the radial channels 710. Surfaces of the body portion 702 (e.g., outward-facing circumferential surfaces 726 and inward-facing circumferential surfaces 728 of the body portion 702) and the inner walls 704 (e.g., outward-facing surfaces 730 of the inner walls 704) can define the outer channel 708.

The body portion 702 of the anode 700 can be a unitary or single continuous component. In contrast to examples that include an end plate coupled to a body portion, the body portion 702 is a single component that extends from the outer surface 714 to an opposite outer surface 732. This eliminates any seam between the end plate and the body portion. This can improve heat dissipation throughout the body portion 702, as seams or interfaces can reduce heat dissipation. Further, this can improve the durability and longevity of the anode 700 by preventing detachment between the end plate and the body portion.

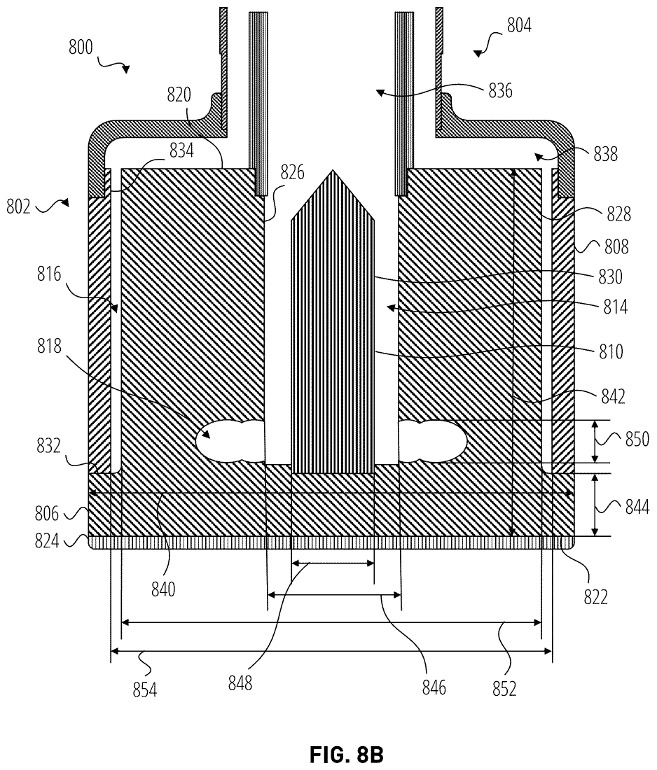

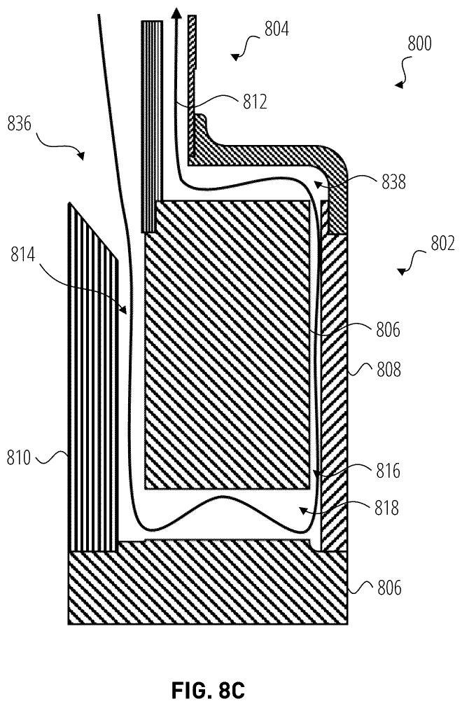

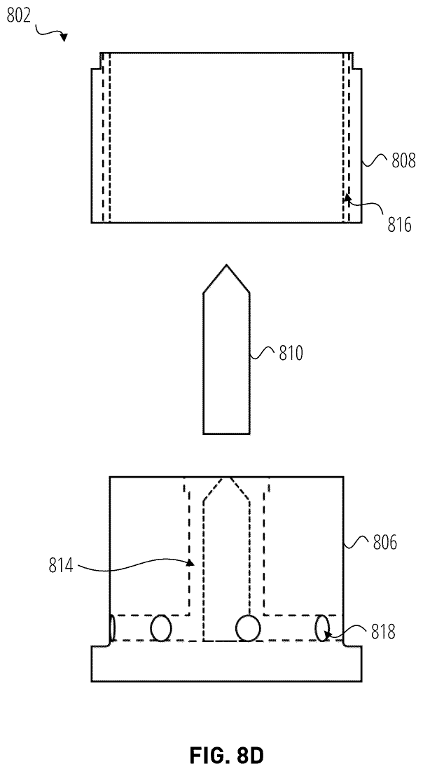

FIGS. 8A through 8D illustrate an example of an anode assembly 800 according to another example. The anode assembly 800 can include an anode 802 and a cooling system 804. The anode 802 can be formed from a body portion 806 and an outer wall 808 and a protrusion 810 coupled to the body portion 806. The anode 802 can be formed with improved manufacturability, improved heat dissipation, and improved durability. FIG. 8A illustrates a top-down view of the anode 802. FIG. 8B illustrates a cross-sectional view of the anode assembly 800 along reference line C-C illustrated in FIG. 8A. FIG. 8C illustrates a partial cross-sectional view of a flow path 812 through the anode assembly 800. FIG. 8D illustrates an exploded view of the anode 802.

The anode 802 can be formed by providing the body portion 806. Channels for the inner channel 814, the outer channel 816, and the radial channels 818 can be formed in the body portion 806 by subtractive manufacturing methods, such as milling, turning, drilling, boring, reaming, water jet machining, or the like. The body portion 806 and the protrusion 810 can further define the outer channel 816 and the inner channel 814, respectively. The channel for the inner channel 814 can be formed by drilling or boring through a first surface 820 of the body portion 806. The first surface 820 can be opposite a second surface 822 of the body portion 806 to which a target 824 is coupled. An inward-facing circumferential surface 826 of the body portion 806 can then define an outer surface of the inner channel 814. The channel for the outer channel 816 can be formed by turning through an outer circumferential surface of the body portion 806. An outward-facing circumferential surface 828 of the body portion 806 can then define an inner surface of the outer channel 816. The channels for the radial channels 818 can be formed by drilling or boring through the outer circumferential surface of the body portion 806 (or through the circumferential surface 828 after forming the channel for the outer channel 816). Circumferential surfaces extending from the outer channel 816 to the inner channel 814 can then define the radial channels 818.

The protrusion 810 can be inserted into the channel formed in the body portion 806 for the inner channel 814 and can be coupled to the body portion 806. The protrusion 810 can be coupled to the body portion 806 through any suitable means, such as brazing, fasteners, clips, glues, threads, welding, soldering, or the like. Outer surfaces of the protrusion 810 can then define inner surfaces of the inner channel 814. The inner channel 814 can be defined between the inward-facing circumferential surface 826 of the body portion 806 and a circumferential surface 830 of the protrusion 810. The protrusion 810 can decrease a cross-sectional area of the inner channel 814, increasing a velocity of coolant through the inner channel 814, and can also help to direct coolant between the inner channel 814 and the radial channels 818. The protrusion 810 can be coupled to the body portion 806 by a means having a high thermal conductivity, such as brazing, which can increase heat transfer from the body portion 806 to the protrusion 810 and can increase heat dissipation to the coolant.

The outer wall 808 can be arranged concentrically with the body portion 806 and can be coupled to the body portion 806. The outer wall 808 can be arranged such that the outer wall 808 surrounds or encircles at least a portion of the body portion 806. The outer wall 808 can be a tube or can otherwise match a shape of the body portion 806. The outer wall 808 can be coupled to the body portion 806 through any suitable means, such as brazing, fasteners, clips, glues, threads, welding, soldering, or the like. The outer wall 808 can be coupled to a third surface 832 of the body portion 806 opposite the second surface 822 to which the target 824 is coupled. The outer wall 808 can have a height equal to a central portion of the body portion 806, such that a proximal surface of the outer wall 808 (proximal to the cooling system 804 and opposite the target 824) is level with the first surface 820 of the body portion 806; however, surfaces of the outer wall 808 and the body portion 806 can be disposed at different levels relative to one another. An inner circumferential surface 834 of the outer wall 808 can define an outer surface of the outer channel 816. The outer channel 816 can be defined between the outward-facing circumferential surface 828 of the body portion 806 and the circumferential surface 834 of the outer wall 808.

The target 824 (e.g., an x-ray target or a target layer) can be coupled to the second surface 822 of the body portion 806 opposite the first surface 820. The target 824 can be coupled to the body portion 806 through any suitable means, such as brazing, fasteners, clips, glues, threads, welding, soldering, or the like.

The body portion 806 of the anode 802 can be a unitary or single continuous component. In contrast to examples that include an end plate coupled to a body portion, the body portion 806 is a single component that extends from the second surface 822 to the opposite first surface 820. This eliminates any seam between the end plate and the body portion. This can improve heat dissipation throughout the body portion 806, as seams or interfaces can reduce heat dissipation. Further, this can improve the durability and longevity of the anode 802 by preventing detachment between the end plate and the body portion. A seam between the body portion 806 and the outer wall 808 can have a decreased surface area and/or be disposed in an area less prone to overheating than the seam between the end plate and the body portion in other examples. This can reduce the likelihood of detachment between the body portion 806 and the outer wall 808 and can improve the durability of the anode 802. Although the anode 802 has been described as being formed by various subtractive manufacturing processes, in some examples, the anode 802 or components thereof (e.g., the body portion 806, the outer wall 808, and/or the protrusion 810) can be formed by additive manufacturing processes, such as 3D printing, casting, or the like.

The method of manufacturing the anode 802 discussed in reference to FIGS. 8A through 8D can be used to form anodes the same as or similar to the anodes 102, 202, 300, 400, 500, 700, discussed above with respect to FIGS. 1 through 5 and 7A through 7C. For example, the body portion 806 and the outer wall 808 can be formed with any of the inner channel, radial channel, and outer channel configurations discussed herein. Various extended surfaces can be formed in the circumferential surface 826 and the circumferential surface 828 of the body portion 806, the circumferential surface 830 of the protrusion 810, and the circumferential surface 834 of the outer wall 808. Protrusions can be formed extending from one of the body portion 806 or the outer wall 808 to the other of the body portion 806 or the outer wall 808 to separate the outer channel 816 into a plurality of outer channels. Forming any of the anodes 102, 202, 300, 400, 500, 700, according to the method of manufacturing the anode 802 can improve the manufacturability, heat dissipation, and durability of the anode.

FIG. 8C illustrates a flow path 812 through the anode 802. Coolant can be supplied to the anode 802 through a coolant inlet 836 of the cooling system 804, can flow along the flow path 812 through the anode 802, and can exit the anode 802 back into the cooling system 804 through a coolant outlet 838. The coolant can flow from the coolant inlet 836, into the inner channel 814, through the inner channel 814 to the radial channels 818, through the radial channels 818 to the outer channel 816, and through the outer channel 816 to the coolant outlet 838. In some examples, the coolant inlet 836 and the coolant outlet 838 can be reversed, and coolant can flow through the anode 802 in a direction opposite the flow path 812. The cooling system 804 can be coupled to the anode 802 by any suitable means, such as brazing, fasteners, clips, glues, threads, welding, soldering, or the like.

FIG. 8B illustrates the radial channels 818 as being disposed at angles relative to a radial direction in the anode 802 and relative to a centerline of the anode 802. The radial channels 818 can extend in a plan perpendicular to the centerline of the anode 802. The radial channels 818 can be disposed at angles tangential to the inward-facing circumferential surface 826 of the body portion 806 that defines the inner channel 814. The radial channels 818 can be disposed within about 5 degrees, within about 10 degrees, or the like from tangent to the inward-facing circumferential surface 826 of the body portion 806. The radial channels 818 can be disposed at an angle 856 relative to a line tangent to the outward-facing circumferential surface 828 of the body portion 806 that defines the outer channel 816. The angle 856 can be in a range from about 65 degrees to about 75 degrees, in a range from about 55 degrees to about 85 degrees, in a range from about 60 degrees to about 80 degrees, about 69 degrees, about 70 degrees, or the like.

Angling the radial channels 818 relative to radial directions of the anode 802 can have several benefits. For example, angling the radial channels 818 at the above-described angles can increase depth tolerances for drilling the radial channels 818 in the body portion 806. Angling the radial channels 818 can increase the respective lengths of the radial channels 818, increase the length of the flow path 812 through the anode 802, and thereby increase heat dissipation through the anode 802. Increasing the lengths of the radial channels 818 increases the surface area of the radial channels 818 that contacts the coolant and increases the velocity of the coolant in the radial channels 818. Angling the radial channels 818 can further increase vorticity of the coolant flowing through the anode 802, which can further increase the length of the flow path 812 and increase heat dissipation through the anode 802. Specifically, the angled radial channels 818 can cause the coolant to flow helically through both the radial channels 818 and the outer channel 816, which can increase the velocity of the coolant and increase heat dissipation from the anode 802.

FIG. 8B illustrates various dimensions of the anode 802. The anode 802 can have a diameter 840 in a range from about 2 inches to about 4 inches, from about 2.5 inches to about 3.9 inches, from about 3 inches to about 3.5 inches, or the like. The anode 802 can have a height 842 between the second surface 822 of the body portion 806 (e.g., to which the target 824 is coupled) and the first surface 820 of the body portion 806. The height 842 can be in a range from about 1 inch to about 2 inches, from about 1.2 inches to about 2 inches, from about 1.3 inches to about 2 inches, from about 1.5 inches to about 1.8 inches, or the like. An end portion of the body portion 806 (e.g., a portion of the body portion 806 between the second surface 822 of the body portion 806 and surfaces of the body portion 806 defining the inner channel 814, the outer channel 816, and/or the radial channels 818) can have a thickness 844 in a range from about 0.2 inches to about 0.5 inches, in a range from about 0.1 inches to about 0.75 inches, in a range from about 0.3 inches to about 0.5 inches, in a range from about 0.45 inches to about 0.55 inches, about 0.5 inches, about 0.4 inches, or the like.

The inner channel 814 can have a diameter 846 in a range from about 0.4 inches to about 1 inch, from about 0.7 inches to about 1.1 inches, from about 0.8 inches to about 1 inch, or the like. The protrusion 810 can have a diameter 848 in a range from about 0.4 inches to about 0.7 inches, from about 0.5 inches to about 0.6 inches, or the like. A cross-sectional area of the inner channel 814 (e.g., a flow area of the inner channel 814 between the body portion 806 and the protrusion 810) can be in a range from about 0.1 in² to about 0.4 in², in a range from about 0.2 in² to about 0.3 in², about 0.36 in², or the like.

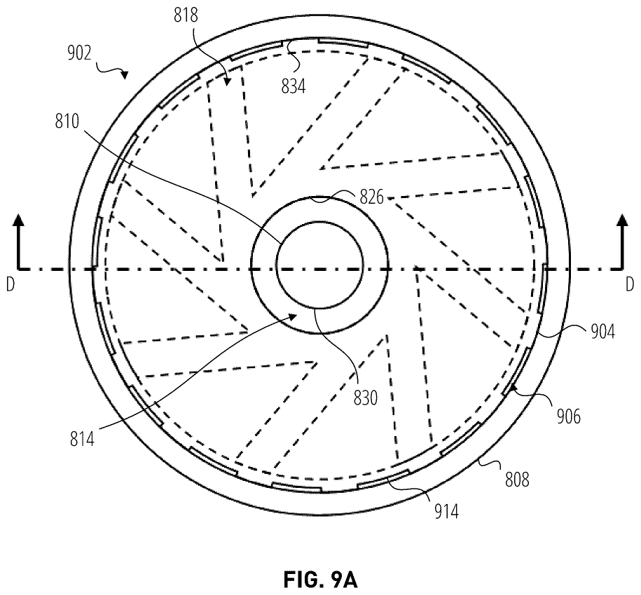

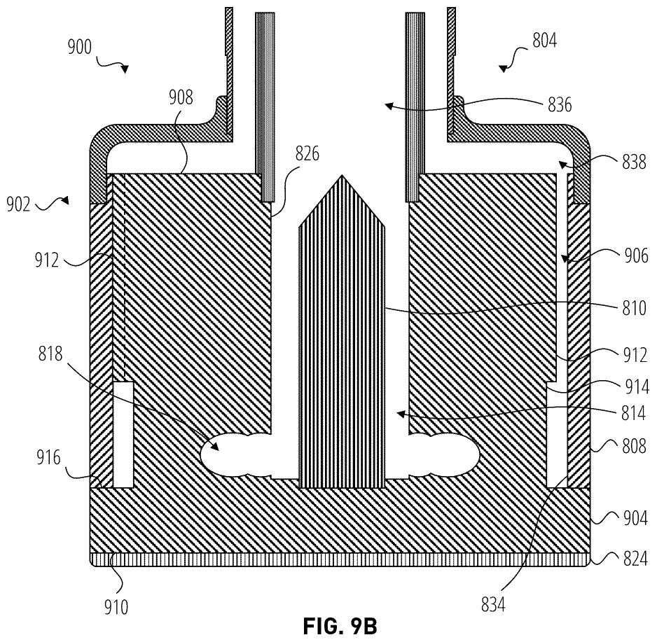

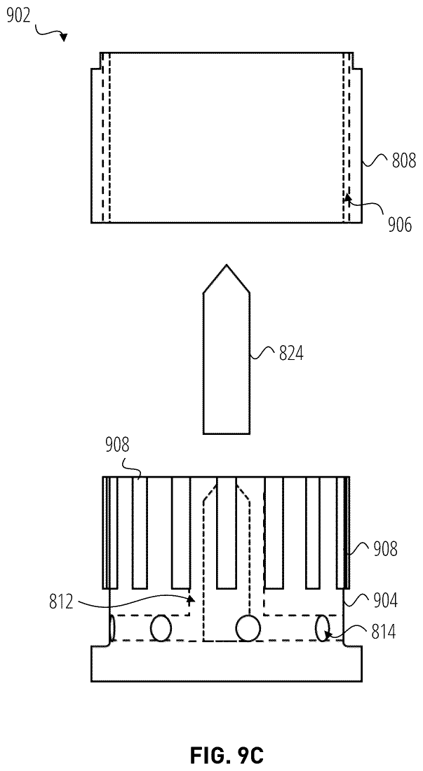

The radial channels 818 can have diameters 850 in a range from about 0.2 inches to about 0.3 inches, from about 0.15 inches to about 0.35 inches, about 0.25 inches, or the like. In the example of FIGS. 9A through 9D, the anode 802 includes 8 radial channels 818; however, any suitable number of the radial channels 818, such as a greater or fewer number than 8 radial channels 818, can be included in the anode 802. In examples in which a greater or fewer number of the radial channels 818 are provided, the diameters 850 of the radial channels 818 can be decreased or increased, respectively, to provide about the same cross-sectional area in the radial channels 818 as the inner channel 814 and the outer channel 816. A cross-sectional area of the radial channels 818 (e.g., a combined flow area of the radial channels 818) can be in a range from about 0.3 in² to about 0.5 in², in a range from about 0.35 in² to about 0.45 in², about 0.39 in², or the like.

An inner diameter 852 of the outer channel 816 can be in a range from about 2.25 inches to about 3.5 inches, from about 2.5 inches to about 3.25 inches, or the like. An outer diameter 854 of the outer channel 816 can be in a range from about 2.3 inches to about 3.6 inches, from about 2.6 inches to about 3.3 inches, or the like. A cross-sectional area of the outer channel 816 (e.g., a flow area of the outer channel 816) can be in a range from about 0.1 in² to about 0.5 in², in a range from about 0.2 in² to about 0.4 in², about 0.36 in², or the like. The inner channel 814 can have a cross-sectional area equal to or greater than the outer channel 816, which can maximize heat transfer in the outer channel 816. Specifically, a velocity of coolant in the outer channel 816 can be equal to or greater than a velocity of coolant in the inner channel 814, which can increase heat transfer in the outer channel 816. The outer channel 816 can be adjacent to areas of the anode 802 having the highest temperatures, and this can increase heat dissipation for the anode 802, while also minimizing pressure drop through the anode 802.

The cross-sectional areas of the inner channel 814, the radial channels 818, and the outer channel 816 can be used to maximize a fluid velocity through the anode 802 and heat dissipation provided to the anode 802, while minimizing pressure drop through the anode 802. Decreasing the cross-sectional areas of the inner channel 814, the radial channels 818, and the outer channel 816 can increase a velocity of coolant through the anode 802 and increase heat dissipation provided to the anode 802. However, decreasing the cross-sectional areas of the inner channel 814, the radial channels 818, and the outer channel 816 can also increase the pressure drop through the anode 802. The cross-sectional areas of the inner channel 814, the radial channels 818, and the outer channel 816 can be selected based on a pump size of the cooling system 804 and heat dissipation requirements for the anode 802.

The dimensions of the anode 802 can be scaled in order to use the anode 802 for various applications, which can use anodes of different dimensions. In such cases, providing various ratios between dimensions of the anode 802 can help to ensure that the anode 802 provides efficient cooling, while having good durability and manufacturability.

For example, a ratio between the outer diameter 854 of the outer channel 816 and the diameter 840 of the anode 802 can be in a range from about 0.8 to about 0.95, about 0.9, or the like. The ratio between the outer diameter 854 of the outer channel 816 and the diameter 840 of the anode 802 can determine the radial location of the outer channel 816 relative to the anode 802 and can be selected based on a location of the target 824, a location of a maximum temperature on the anode 802, and the like. A ratio between the diameter 846 of the inner channel 814 and the diameter 840 of the anode 802 can be in a range from about 0.15 to about 0.35, about 0.27, or the like. A ratio between the diameter 848 of the protrusion 810 and the diameter 846 of the inner channel 814 can be in a range from about 0.5 to about 0.75, about 0.63, or the like. A ratio between the cross-sectional area of the outer channel 816 to the cross-sectional area of the inner channel 814 can be in a range from about 0.5 to about 0.75, about 0.64, or the like. A ratio between the cross-sectional area of the outer channel 816 to the combined cross-sectional area of the radial channels 818 can be in a range from about 0.45 to about 0.7, about 0.47, or the like. A ratio between the cross-sectional area of the inner channel 814 to the combined cross-sectional area of the radial channels 818 can be in a range from about 0.75 to about 1.10, about 0.92, or the like. Increasing the height 842 of the anode 802 can increase cooling in the anode 802 in a relatively linear manner such that a power capacity for an x-ray tube including the anode 802 can increase relatively linearly. For example, a ratio of maximum power capacity for an x-ray tube to the height 842 can be in a range from about 9 kW/inch to about 12 kW/in, about 9.64 kW/inch, or the like.

FIGS. 9A through 9C illustrate an example of an anode assembly 900. The anode assembly 900 can include an anode 902 formed from a body portion 904 including extended surfaces 912. The extended surfaces 912 and the body portion 904 can define outer channels 906 between the body portion 904 and an outer wall 808. The anode assembly 900 can be similar to the anode assembly 800, except that the anode assembly 900 further comprises the extended surfaces 912 between the body portion 904 and the outer wall 808. The anode assembly 900 can be formed from materials and processes the same as or similar to the anode assembly 800, discussed above with respect to FIGS. 8A through 8D. FIG. 9A illustrates a top-down view of the anode 902. FIG. 9B illustrates a cross-sectional view of the anode assembly 900 along reference line D-D illustrated in FIG. 9A. FIG. 9C illustrates an exploded view of the anode 902.

The anode 902 can be formed by providing the body portion 904. Channels for the inner channel 814, the outer channels 906, and the radial channels 818 can be formed in the body portion 904 by subtractive manufacturing methods, such as milling, turning, drilling, boring, reaming, water jet machining, or the like. The body portion 904 and a protrusion 810 can further define the outer channels 906 and the inner channel 814, respectively. The channel for the inner channel 814 can be formed by drilling or boring through a first surface 908 of the body portion 904. The first surface 908 can be opposite a second surface 910 of the body portion 904 to which a target 824 is coupled. An inward-facing circumferential surface 826 of the body portion 904 can then define an outer surface of the inner channel 814.

Channels for the outer channels 906 can be formed by a combination of subtracting manufacturing methods through an outer circumferential surface of the body portion 904 and the first surface 908 of the body portion 904. The subtractive manufacturing methods used to form the channels for the outer channels 906 can define the extended surfaces 912. In some examples, the extended surfaces 912 can be formed separately from the body portion 904 and coupled to the body portion 904 through any suitable means, such as brazing, fasteners, clips, glues, threads, welding, soldering, or the like. The extended surfaces 912 and an outward-facing circumferential surface 914 of the body portion 904 can then define surfaces of the outer channels 906.

The channels for the radial channels 818 can be formed by drilling or boring through the outer circumferential surface of the body portion 904 (or through the circumferential surface 914 after forming the outer channels 906 and the extended surfaces 912). Circumferential surfaces extending from the outer channels 906 to the inner channel 814 can then define the radial channels 818.

The protrusion 810 can be inserted into the channel formed in the body portion 904 for the inner channel 814 and can be coupled to the body portion 904. The protrusion 810 can be coupled to the body portion 904 through any suitable means, such as brazing, fasteners, clips, glues, threads, welding, soldering, or the like. The inner channel 814 can be defined between the body portion 904 and the protrusion 810. The protrusion 810 can be coupled to the body portion 904 by a means having a high thermal conductivity, such as brazing, which can increase heat transfer from the body portion 904 to the protrusion 810 and can increase heat dissipation to the coolant.

The outer wall 808 can be arranged concentrically with the body portion 904 and can be coupled to the body portion 904. The outer wall 808 can be arranged such that the outer wall 808 surrounds or encircles at least a portion of the body portion 904. The outer wall 808 can be a tube or can otherwise match a shape of the body portion 904. The outer wall 808 can have a height equal to a central portion of the body portion 904, such that a proximal surface of the outer wall 808 (proximal to the cooling system 804 and opposite the target 824) is level with the first surface 908 of the body portion 904; however, surfaces of the outer wall 808 and the body portion 904 can be disposed at different levels relative to one another. The outer wall 808 can be coupled to the body portion 904 through any suitable means, such as brazing, fasteners, clips, glues, threads, welding, soldering, or the like. The outer wall 808 can be coupled to a third surface 916 of the body portion 904 opposite the second surface 910. In some examples, the outer wall 808 can be further coupled to the extended surfaces 912.

In examples in which the outer wall 808 is coupled to the third surface 916 and the extended surfaces 912, individual outer channels 906 can be defined radially between the circumferential surface 914 and an inner circumferential surface 834 of the outer wall 808. The individual outer channels 906 can be defined between each pair of neighboring extended surfaces 912. In examples in which the outer wall 808 is coupled to the third surface 916 without being coupled to the extended surfaces 912, a single outer channel 906 can encircle or surround the body portion 904. The inner circumferential surface 834 of the outer wall 808 can define an outer surface of the outer channel 906. The outer channel 906 can be defined between the circumferential surface 834 of the outer wall 808 and the outward-facing circumferential surface 914 and the extended surfaces 912 of the body portion 904. The extended surfaces 912 can increase a surface area of the body portion 904 that contacts the coolant and can increase a velocity of the coolant by decreasing a cross-sectional area of the outer channels 906.

The target 824 (e.g., an x-ray target or a target layer) can be coupled to the second surface 910 of the body portion 904 opposite the first surface 908. The target 824 can be coupled to the body portion 904 through any suitable means, such as brazing, fasteners, clips, glues, threads, welding, soldering, or the like.

The body portion 904 of the anode 902 can be a unitary or single continuous component. In contrast to examples that include an end plate coupled to a body portion, the body portion 904 is a single component that extends from the second surface 910 to the opposite first surface 908. This eliminates any seam between the end plate and the body portion. This can improve heat dissipation throughout the body portion 904, as seams or interfaces can reduce heat dissipation. Further, this can improve the durability and longevity of the anode 902 by preventing detachment between the end plate and the body portion. A seam between the body portion 904 and the outer wall 808 can have a decreased surface area and/or be disposed in an area less prone to overheating than the seam between the end plate and the body portion in other examples. This can reduce the likelihood of detachment between the body portion 904 and the outer wall 808 and can improve the durability of the anode 902. Although the anode 902 has been described as being formed by various subtractive manufacturing processes, in some examples, the anode 902 or components thereof (e.g., the body portion 904, the outer wall 808, and/or the protrusion 810) can be formed by additive manufacturing processes, such as 3D printing, casting, or the like.

FIGS. 9A through 9C illustrate the extended surfaces 912 as extending from the circumferential surface 914 of the body portion 904 into the outer channels 906 (or defining the outer channels 906). However, extended surfaces can extend from the circumferential surface 834 of the outer wall 808 into the outer channels 906, from the body portion 904 into the radial channels 818, from the circumferential surface 826 of the body portion 904 into the inner channel 814, and/or from the protrusion 810 into the inner channel 814 in addition to or instead of the extended surfaces 912. Any extended surfaces can be included in the anode 902 to increase a surface area between the anode 902 and the coolant flowing therethrough, to decrease cross-sectional areas of the inner channel 814, the radial channels 818, and/or the outer channels 906, and/or to increase a velocity of the coolant flowing through the anode 902.

FIGS. 9A through 9C illustrate the extended surfaces 912 as fins; however, the extended surfaces 912 can include any surface profiles or characteristics that increase a surface area between the channels 814, 818, 906 and the anode 902. For example, the extended surfaces 912 can include fins, textured surfaces, porous surfaces (e.g., porous media), or the like. The extended surfaces 912 can be straight extended surfaces (e.g., fins) with uniform cross-sections, or can have varied cross-sectional profiles. In examples in which the extended surfaces 912 are fins, the extended surfaces 912 can be V-shaped, U-shaped, triangular, or have any other suitable cross-sectional shape. The extended surfaces 912 can spiral along a length of the channels 814, 818, 906, which can further increase vorticity in the coolant flowing through the channels 814, 818, 906, increase the velocity of the coolant, and increase heat dissipation from the anode 902 to the coolant.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An anode for an x-ray tube, the anode comprising:
a body portion defining:
an inner channel;
an outer channel; and
a radial channel configured to direct a coolant between the inner channel and the outer channel.

2. The anode of claim 1, wherein:
the inner channel is configured to direct the coolant in a first direction; and
the outer channel is configured to direct the coolant in a second direction opposite the first direction.

3. The anode of claim 1, further comprising a plurality of extended surfaces extending into the inner channel.

4. The anode of claim 1, wherein a surface of the body portion facing away from the inner channel comprises a plurality of extended surfaces extending into the outer channel.

5. The anode of claim 1, wherein a surface of the body portion facing the inner channel comprises a plurality of extended surfaces extending into the outer channel.

6. The anode of claim 1, further comprising an end plate coupled to the body portion, the end plate at least partially defining the radial channel and having a thickness in a range from 0.2 inches to 0.5 inches.

7. The anode of claim 1, further comprising:
an end plate coupled to the body portion; and
an x-ray target layer attached to a first surface of the end plate;
wherein the radial channel is configured to direct the coolant along a second surface of the end plate opposite the first surface.

8. The anode of claim 1, wherein the body portion defines a plurality of outer channels disposed at different radial distances in the body portion.

9. An x-ray tube comprising:
a cathode;
an anode defining a plurality of channels, the plurality of channels comprising:
an inner channel configured to direct a flow of a coolant in a first direction; and
an outer channel configured to direct a flow the coolant in a second direction opposite the first direction;
a cooling system coupled to the channels, the cooling system comprising a coolant inlet and a coolant outlet; and
an enclosure at least partially surrounding the cathode, the anode, and the cooling system.

10. The x-ray tube of claim 9, wherein the plurality of channels further comprise a radial channel in fluid communication with the inner channel and the outer channel.

11. The x-ray tube of claim 10, wherein:
the cooling system is coupled to the plurality of channels at a proximal end of the anode; and
the radial channel is disposed within a distal end of the anode.

12. The x-ray tube of claim 9, wherein the coolant inlet and the coolant outlet are concentrically arranged.

13. The x-ray tube of claim 9, wherein:
the plurality of channels further comprise a plurality of outer channels;
the plurality of outer channels is disposed at greater radial distances from a center of the anode than the inner channel; and
the plurality of outer channels at least partially encircle the inner channel.

14. The x-ray tube of claim 13, wherein the plurality of channels further comprise a plurality of radial channels, each of the radial channels being in fluid communication with the inner channel and at least two of the outer channels.

15. A method of manufacturing an anode, comprising:
providing a body portion defining a first channel and a second channel extending through a length of the body portion; and
coupling an end plate to the body portion, the end plate at least partially defining a radial channel fluidly coupled between the first channel and the second channel.

16. The method of claim 15, wherein providing the body portion comprises:
concentrically arranging a first body portion relative to a second body portion; and
coupling the first body portion to the second body portion.

17. The method of claim 15, wherein:
providing the body portion comprises concentrically arranging a first body portion relative to a second body portion;
the first body portion and the second body portion define the first channel and the second channel; and
coupling the end plate to the body portion comprises coupling the first body portion and the second body portion to the end plate.

18. The method of claim 15, wherein providing the body portion comprises machining the first channel and the second channel in the body portion.

19. The method of claim 18, wherein providing the body portion further comprises machining the body portion to at least partially define the radial channel.

20. The method of claim 15, further comprising forming the body portion by an additive manufacturing process.
